(19) United States
(12) Patent Application Publication
(10) Pub. No.: US 2026/0220276 A1
(43) Pub. Date: Jul. 30, 2026

(54) FACE RECOGNITION ATTACK TEST

(71) Applicant: Alipay (Hangzhou) Information Technology Co., Ltd., Hangzhou (CN)

(72) Inventor: Hanruo QIU, Hangzhou (CN)

(21) Appl. No.: 19/157,357

(22) PCT Filed: Apr. 16, 2024
(86) PCT No.: PCT/CN2024/087877

§ 371 Date: Aug. 17, 2025

(30) Foreign Application Priority Data
Jun. 25, 2023 (CN) 202310755114.6

(51) Int. Cl. G06F 21/57

(52) U.S. Cl. CPC G06F 21/577; G06F 2221/034

(57) ABSTRACT

One or more embodiments of this specification disclose a face recognition attack test method and system. The method includes: determining at least one first pose of a test terminal; determining a plurality of second poses of a target terminal, where a target application program is installed on the target terminal; adjusting the target terminal to the plurality of second poses; obtaining a recognition result of the target application program for a test action played by the test terminal when being in each second pose; and if the recognition result is a recognition success result, determining an attack pose based on the second pose and the first pose that are corresponding to the recognition result.

### TECHNICAL FIELD

The present disclosure relates to the field of computer technologies, and in particular, to face recognition attack test methods and systems.

### BACKGROUND

Face verification methods generally fall into silent single-frame biometric checks and interactive biometric checks involving actions (blinking, opening mouth, shaking head, nodding, etc.). Generally speaking, verification methods with interactive actions maintain a higher security threshold compared to silent biometric checks. In test processes of face recognition applications with interactive actions, a manual testing method has always been conducted, that is, testers perform corresponding actions according to the application's actions to attack a face recognition system. This manual testing method proves inefficient and incurs substantial cost investments in testing.

### SUMMARY

One or more embodiments of this specification describe a face recognition attack test method and system, and can complete a face attack test in an automated manner, thereby improving test efficiency.

According to a first aspect, a face recognition attack test method is provided, and the method includes the following steps: determining at least one first pose of a test terminal; determining a plurality of second poses of a target terminal, where a target application program is installed on the target terminal; adjusting the target terminal to the plurality of second poses; obtaining a recognition result of the target application program for a test action played by the test terminal when being in each second pose; and if the recognition result is a recognition success result, determining an attack pose based on the second pose and the first pose that are corresponding to the recognition result.

In an optional implementation of the method according to the first aspect, the attack pose includes distance data and angle data; and the determining an attack pose based on the second pose and the first pose that are corresponding to the recognition success result specifically includes: determining a relative distance between the test terminal and the target terminal based on the second pose and the first pose that are corresponding to the recognition success result, to obtain the distance data; and determining, based on the second pose and the first pose that are corresponding to the recognition success result, a three-dimensional motion pose of the test terminal relative to the target terminal, and obtaining the angle data based on the three-dimensional motion pose.

In an optional implementation of the method according to the first aspect, the test terminal prestores test action data; and the playing, by the test terminal, the test action specifically includes: collecting a face recognition interface image of the target application program in real time in response to a received test task; extracting action prompt information from the face recognition interface image; and determining and playing a test action based on the action prompt information.

In an optional implementation of the method according to the first aspect, the test terminal prestores test action data; and the obtaining a recognition result of the target application program for a test action played by the test terminal when being in each second pose specifically includes: playing, by the test terminal, a test action according to a predetermined play sequence; and for each test action, controlling the target terminal to traverse the plurality of second poses, and obtaining a recognition result of the target application program for the test action when being in each second pose.

According to a second aspect, another face recognition attack test method is provided, where the method is applied to a face recognition attack test system, and the face recognition attack test system includes a robot arm, a test terminal, a target terminal, and a control end; the test terminal is configured to play a test action in at least one first pose in response to a test task delivered by the control end; the robot arm is configured to adjust the target terminal to a plurality of second poses predetermined for the test task in response to the test task delivered by the control end; the target terminal is disposed on the robot arm and installed with a target application program, and is configured to recognize the test action by using the target application program when moving to each second pose; and the control end is configured to generate the test task and deliver the test task to the robot arm and the test terminal; and determine an attack pose based on the second pose and the first pose that are corresponding to a recognition success result of the target application program for the test action.

In an optional implementation of the method according to the second aspect, the attack pose includes distance data and angle data; and the control end is specifically configured to determine a relative distance between the test terminal and the target terminal based on the second pose and the first pose that are corresponding to the recognition success result, to obtain the distance data; and determine, based on the second pose and the first pose that are corresponding to the recognition success result, a three-dimensional motion pose of the test terminal relative to the target terminal, and obtain the angle data based on the three-dimensional motion pose.

In an optional implementation of the method according to the second aspect, the test terminal prestores test action data; and the test terminal is specifically configured to: collect a face recognition interface image of the target application program in real time in response to a test task delivered by the control end; extract action prompt information from the face recognition interface image; and determine and play a test action based on the action prompt information.

In an optional implementation of the method according to the second aspect, the test terminal prestores test action data; the test terminal is specifically configured to play a test action according to a predetermined play sequence; and the control end is specifically configured to: for each test action, adjust a pose of the target terminal by using the robot arm, so the target terminal traverses the plurality of second poses, and obtains a recognition result of the target application program for the test action when being in each second pose.

According to a third aspect, a face recognition attack test system is provided, including a robot arm, a test terminal, a target terminal, and a control end; the test terminal is configured to play a test action in at least one first pose in response to a test task delivered by the control end; the robot arm is configured to adjust the target terminal to a plurality of second poses predetermined for the test task in response to the test task delivered by the control end; the target terminal is disposed on the robot arm and installed with a target application program, and is configured to recognize the test action by using the target application program when moving to each second pose; and the control end is configured to generate the test task and deliver the test task to the robot arm and the test terminal; and determine an attack pose based on the second pose and the first pose that are corresponding to a recognition success result of the target application program for the test action.

In an optional implementation of the system according to the third aspect, the robot arm includes a controller, a driver, and an actuator; the control end is specifically configured to determine a control instruction based on the plurality of second poses and a predetermined motion path of the target terminal; and the controller is configured to execute the control instruction to control the driver to adjust a pose of the target terminal to the plurality of second poses.

According to a fourth aspect, an evaluation method is provided, where the method includes: determining at least one target terminal, where at least one target application program is installed on the at least one target terminal; testing the target application program by using the face recognition attack test method according to the first aspect, and determining an attack pose of the target application program; playing, by using a test terminal, a predetermined attack action based on the attack pose, and obtaining a recognition result of the target application program for the attack action; and determining an evaluation result of the target application program based on a total quantity of attacks of the attack action and a quantity of successful recognition in the recognition result.

The face recognition attack test method and system provided in one or more embodiments of this specification can automatically complete a face recognition attack test, effectively reduce labor costs, and efficiently mine a security vulnerability of interactive face scanning.

### BRIEF DESCRIPTION OF DRAWINGS

To describe the technical solutions in one or more embodiments of this specification or in the conventional technology more clearly, the following briefly describes the accompanying drawings needed for describing the embodiments or the conventional technology. Clearly, the accompanying drawings in the following description merely show some embodiments of this specification, and a person of ordinary skill in the art can still derive other drawings from these accompanying drawings without creative efforts.

FIG. 1 is a flowchart illustrating a face recognition attack test method, according to one or more embodiments of this specification;

FIG. 2 is a schematic structural diagram illustrating a face recognition attack test system, according to one or more embodiments of this specification;

FIG. 3 is a schematic structural diagram illustrating a robot arm, according to one or more embodiments of this specification;

FIG. 4 is a flowchart illustrating another face recognition attack test method, according to one or more embodiments of this specification; and

FIG. 5 is a flowchart illustrating an evaluation method, according to one or more embodiments of this specification.

### DESCRIPTION OF EMBODIMENTS

To make a person skilled in the art better understand the technical solutions in this specification, the following clearly and comprehensively describes the technical solutions in the embodiments of this specification with reference to the accompanying drawings in the embodiments of this specification. Clearly, the described embodiments are merely some but not all of the embodiments of this specification. All other embodiments obtained by a person of ordinary skill in the art based on the embodiment of this specification without creative efforts shall fall within the protection scope of this specification.

It is worthwhile to note that the steps of the corresponding method are not necessarily performed in the sequence shown and described in this specification in other embodiments. In some other embodiments, the method can include more or fewer steps than those described in this specification. In addition, a single step described in this specification may be split into a plurality of steps in other embodiments for description; and a plurality of steps described in this specification may be combined into a single step in other embodiments for description.

Currently, during face verification processes, an interactive face scanning method is commonly adopted. Interactive face scanning specifically refers to a terminal interface providing prompt actions such as opening mouth, blinking, shaking head, nodding, etc., during the face scanning process. Users are required to perform corresponding actions according to these interface prompts. A face recognition window on the terminal interface then identifies these actions to confirm whether face verification is successful, thereby determining whether to log into a corresponding APP.

To prevent attacks by black and gray industries on the face verification process of APPS, which could lead to user privacy breaches or even financial losses, various APPs typically incorporate anti-spoofing attack functions. To evaluate capabilities and vulnerabilities of various APPs in defending against spoofing attacks, face recognition attack test is typically conducted.

For APPs that employ interactive actions for face verification, due to complexity of attack test processes involving interactive actions, the industry commonly adopts manual test methods. This involves testers performing corresponding actions (e.g., shaking head, nodding, opening mouth, or blinking) based on prompts displayed on the interactive interface of the APP. The built-in recognition algorithm of the APP then captures and recognizes the tester's actions within the face scanning frame. During the test process, it is necessary to record the tester's attack test data and a corresponding recognition result of the APP to evaluate the APP's capability in defending against spoofing attacks and find vulnerabilities of the APP's capability in defending against spoofing attacks.

However, in actual operations, the position of the face within the face scanning frame and the relative distance between the tester and the terminal are uncontrollable. This makes it difficult to reproduce vulnerabilities after being discovered and results in low efficiency in the manual vulnerability discovery process. On the other hand, during manual test, recording of data is asynchronous and carries human subjective factors, making it prone to misrecording test result data and leading to analytical deviations.

In view of this, this specification aims to provide a face recognition attack test method and system, and can complete a face attack test in an automated manner.

The following further describes in detail the manual review capability evaluation method and system described in embodiments of this specification with reference to the accompanying drawings and specific embodiments of this specification. However, the detailed description does not constitute a limitation on embodiments of this specification.

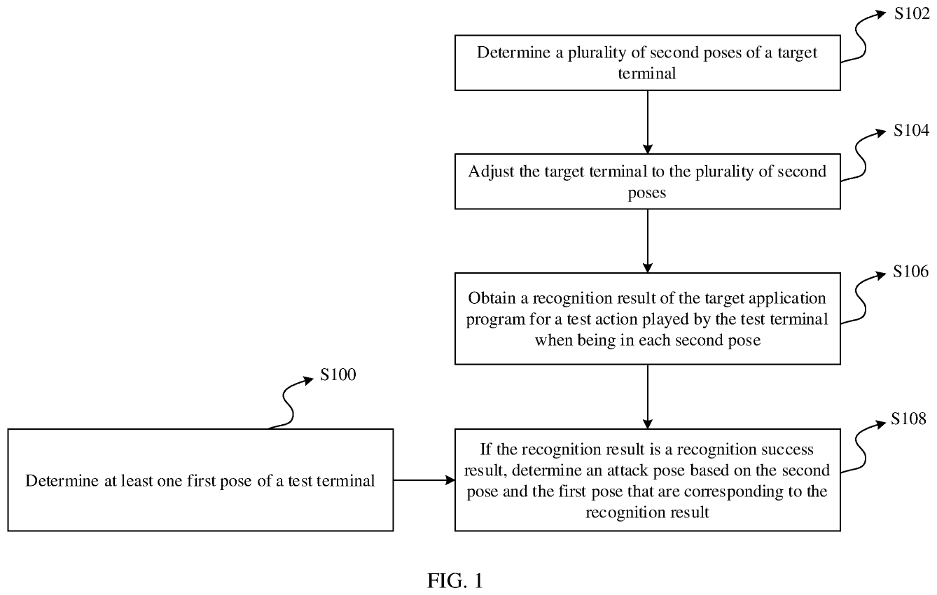

Referring to FIG. 1, FIG. 1 shows a manual review capability evaluation method according to an embodiment. The method specifically includes step S100 to step S108.

S100: Determine at least one first pose of a test terminal.

The test terminal is configured to play test actions, such as nodding, raising head, shaking head, opening mouth, and blinking.

In an example embodiment of this specification, the test terminal can be a display device that can play a test action, such as a display, a high-definition screen, or a terminal device with a display, such as a computer, a television, or an ipad.

In an example embodiment of this specification, a position of the test terminal in a test process can remain unchanged or can be changed.

In an example embodiment of this specification, a first pose of the test terminal includes a position and an angle of the test terminal in a coordinate system of a test site. A reference object of a known position can be disposed in the test site, and then position data of the test terminal is determined by using a three-point positioning method. After the position data are determined, angle data of the test terminal relative to a predetermined reference direction, such as a deflection angle and a pitch angle, can be measured.

S102: Determine a plurality of second poses of a target terminal.

A target application program to be tested is deployed in the target terminal. When the target application program is started, a test action played by the test terminal is collected by using a detection frame in an interaction interface; and then a collected test action is recognized by using a built-in recognition program, and a recognition result is presented by using the interaction interface.

In an example embodiment of this specification, the target terminal can be a terminal device that can have the target application program installed, such as a computer, a mobile phone, or an access control system or a gate system with an interactive face recognition function.

In an example embodiment of this specification, the second pose can be predetermined, or can be randomly selected in a test process. The second pose of the target terminal includes the position and the angle of the target terminal in the coordinate system of the test site, and can be obtained by a pose sensor included in the target terminal from motion data of the target terminal in the test process, so as to determine the plurality of second poses of the target terminal based on a predetermined reference position.

In an example embodiment of this specification, the second pose of the target terminal is a relative pose of the target terminal that uses the test terminal as a reference object, including distance data between the target terminal and the test terminal, and relative angle data between the target terminal and the test terminal, for example, a deflection angle and a pitch angle.

S104: Adjust the target terminal to the plurality of second poses.

In an example embodiment of this specification, the pose of the target terminal can be adjusted by using a grasping device, for example, the target terminal can be grasped by using a robot arm. A motion path and an action instruction of the robot arm are set so the robot arm adjusts the grasped target terminal to the plurality of second poses.

S106: Obtain a recognition result of the target application program for a test action played by the test terminal when being in each second pose.

In an example embodiment of this specification, a recognition algorithm of the target application program can be adjusted, so the target application program can recognize a single action and give a recognition result. Then, the test terminal can play the test action according to a predetermined play sequence, control the target terminal to traverse all second poses for each test action, and obtain a recognition result of the target application program for the test action when being in each second pose.

In an example embodiment of this specification, the test terminal can collect, in response to a received test task, a face recognition interface image of the target application program in real time, recognize action prompt information in the face recognition interface image, determine a test action according to the recognized action prompt information, and play the test action.

In an example embodiment of this specification, the test action can be prestored in the test terminal, or can be read from a storage device by the test terminal. The test terminal is connected to the storage device by using a network link, and the network link is used to provide a communication medium between the test terminal and the storage device, including various wired or wireless networks such as a data bus, Bluetooth, and Wi-Fi.

In an example embodiment of this specification, test actions can be stored in various forms of video format, such as MPEG, MPG, DAT, AVI, MOV, ASF, WMV, MKV, FLVRMVB, and MP4. The test terminal is configured with a player that can decode and play a video in a corresponding format.

In an example embodiment of this specification, a timestamp at which each second pose is reached and a timestamp of a recognition result can be automatically recorded by the target terminal, a timestamp at which a test action is played is determined from a playback record of the test terminal, and a matching result of the pose data, the test result, and the test action can be obtained through timestamp matching. Based on this matching result, a security vulnerability of the target application program in a face recognition attack can be analyzed.

S108: If the recognition result is a recognition success result, determine an attack pose based on the second pose and the first pose that are corresponding to the recognition result.

In an example embodiment of this specification, the target terminal can record all recognition results, and then select the test action and the pose data that are corresponding to the recognition success result to determine the attack pose.

In an example embodiment of this specification, only the recognition success result can be recorded by setting a data recording program of the target terminal. Then, the attack pose is determined according to the test action and the pose data that are corresponding to the recognition success result.

The attack pose described in this embodiment is a relative pose between the target terminal and the test terminal, and includes distance data and angle data. In an example embodiment of this specification, the determining an attack pose based on the second pose and the first pose that are corresponding to the recognition success result specifically includes: determining a relative distance between the test terminal and the target terminal based on the second pose and the first pose that are corresponding to the recognition success result, to obtain the distance data; and determining, based on the second pose and the first pose that are corresponding to the recognition success result, a three-dimensional motion pose of the test terminal relative to the target terminal, and obtaining the angle data based on the three-dimensional motion pose.

It can be understood that in the face recognition attack test method shown in FIG. 1, a test action video is played by the test terminal, and the target application program in the target terminal performs an attack test on the test action in a recognition manner. During the test, both the first pose of the test terminal and the second pose of the target terminal are determined. Therefore, the attack pose can be determined, so as to repeat the attack process in the attack pose. The entire process is completed automatically. Compared with manually performing face recognition attack tests, the method can effectively reduce labor costs and improve test efficiency.

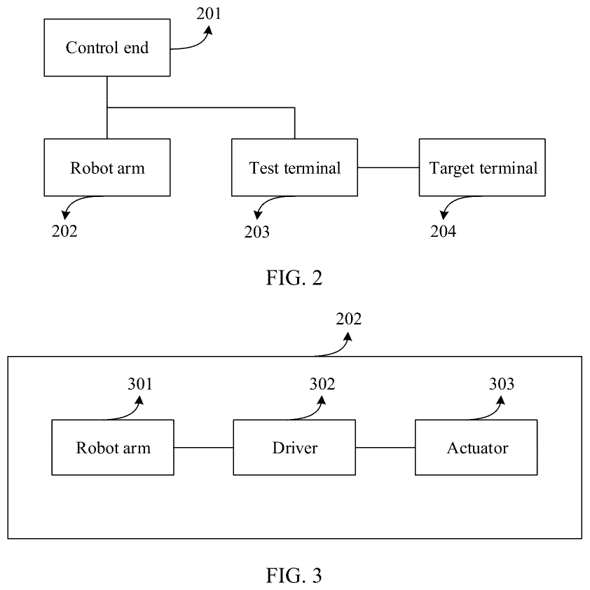

Corresponding to the above-mentioned face recognition attack test method, this embodiment further provides a face recognition attack test system. Referring to FIG. 2, FIG. 2 is a structural diagram of a face recognition attack test system according to an example embodiment. The system includes a control end 201, a robot arm 202, a test terminal 203, and a target terminal 204.

The test terminal 203 is configured to play a test action in at least one first pose in response to a test task delivered by the control end 201.

The robot arm 202 is configured to adjust the target terminal 204 to a plurality of second poses predetermined for the test task in response to the test task delivered by the control end 201.

The target terminal 204 is disposed on the robot arm 202 and installed with a target application program, and is configured to recognize the test action by using the target application program when moving to each second pose.

The control end 201 is configured to generate the test task and deliver the test task to the robot arm 202 and the test terminal 203; and determine an attack pose based on the second pose and the first pose that are corresponding to a recognition success result of the target application program for the test action.

In an example embodiment of this specification, the control end 201 controls, by delivering a test task, the robot arm 202 and the target terminal 204 to complete the above-mentioned functions. For example, a motion path of the robot arm 202 can be set for the test task, so the robot arm 202 moves the target terminal 204 to a predetermined second pose at a specified time point. The target terminal 204 can set, by using a predetermined working program, the target application program to recognize, at each time point corresponding to the second pose, a test action played by the test terminal.

In this scenario, the control end 201 separately communicatively connects to the robot arm 202 and the target terminal 204 by using a wired or wireless network.

In an example embodiment of this specification, the control end 201 can be separately connected to the robot arm 202, the test terminal 203, and the target terminal 204 by using a wired or wireless network, and deliver the test task to control the robot arm 202, the test terminal 203, and the target terminal 204 to complete the above-mentioned functions.

In an example embodiment of this specification, the control end 201 can be a physical server of an independent host, or can be a virtual server carried in a host cluster.

In an example embodiment of this specification, the test terminal 203 can prestore a test action, and the test action data can be directly stored in a video format. A player that can decode and play the test action data is configured in the test terminal 203.

In an example embodiment of this specification, the test terminal 203 can alternatively read the test action data from an external memory in response to the test task. The test action data can be directly stored in a video format, and a player that can decode and play the test action data is configured in the test terminal 203.

Referring to FIG. 3, in an example embodiment of this specification, the robot arm 202 includes a controller 301, a driver 302, and an actuator 303. The control end 201 is specifically configured to determine a control instruction based on the plurality of second poses and a predetermined motion path of the target terminal. The controller 301 is configured to execute the control instruction delivered by the control end 201, and control the driver 302 to drive the actuator 303 to adjust a pose of the target terminal 204 to a predetermined plurality of second poses.

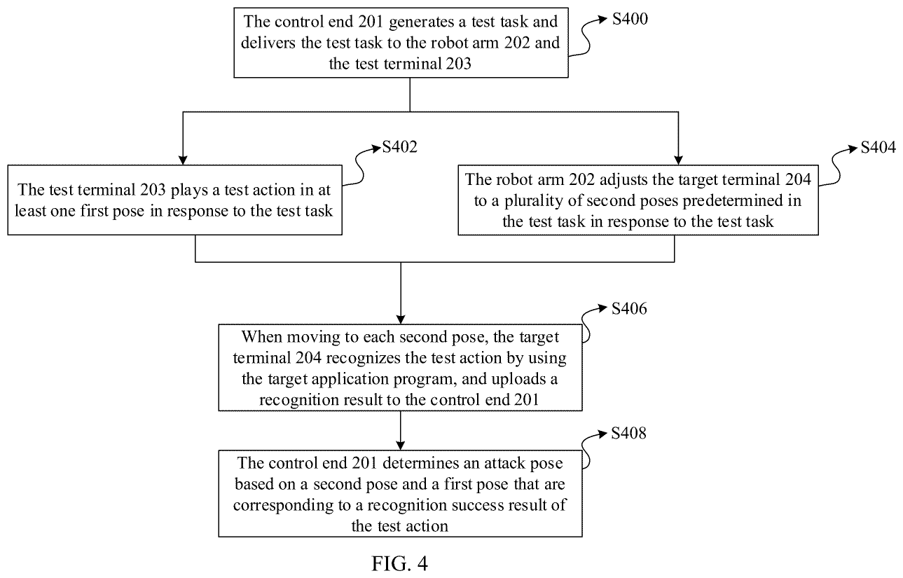

Referring to FIG. 4, a face attack test method of the above-mentioned face recognition attack test system is as follows:
S400: The control end 201 generates a test task and delivers the test task to the robot arm 202 and the test terminal 203.
S402: The test terminal 203 plays a test action in at least one first pose in response to the test task.
S404: The robot arm 202 adjusts the target terminal 204 to a plurality of second poses predetermined in the test task in response to the test task.
S406: When moving to each second pose, the target terminal 204 recognizes the test action by using the target application program, and uploads a recognition result to the control end 201.
S408: The control end 201 determines an attack pose based on a second pose and a first pose that are corresponding to a recognition success result of the test action.

In an example embodiment of this specification, the attack pose includes distance data and angle data. The control end 201 is specifically configured to: determine a relative distance between the test terminal 203 and the target terminal 204 based on the second pose and the first pose that are corresponding to the recognition success result, to obtain the distance data; and determine, based on the second pose and the first pose that are corresponding to the recognition success result, a three-dimensional motion pose of the test terminal 203 relative to the target terminal 204, and obtain the angle data based on the three-dimensional motion pose.

In an example embodiment of this specification, the test terminal 203 prestores test action data. The test terminal 203 is specifically configured to: collect a face recognition interface image of the target application program in real time in response to a test task delivered by the control end 201; extract action prompt information from the face recognition interface image; and determine and play a test action based on the action prompt information.

In an example embodiment of this specification, the test terminal 203 prestores test action data.

The test terminal 203 is specifically configured to play a test action according to a predetermined play sequence; and the control end 201 is specifically configured to: for each test action, adjust a pose of the target terminal 204 by using the robot arm 202, so the target terminal 204 traverses all predetermined second poses, and obtains a recognition result of the target application program for the test action when being in each second pose.

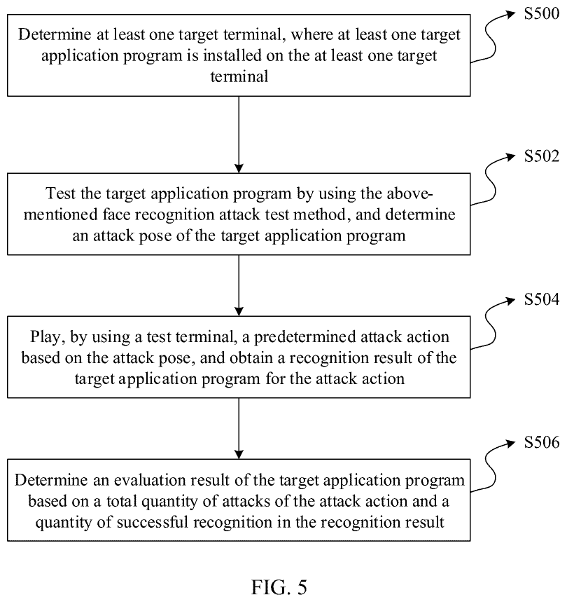

Referring to FIG. 5, an embodiment of this specification provides an evaluation method, and the method includes the following steps.
S500: Determine at least one target terminal, where at least one target application program is installed on the at least one target terminal.
S502: Test the target application program by using the above-mentioned face recognition attack test method, and determine an attack pose of the target application program.
S504: Play, by using a test terminal, a predetermined attack action based on the attack pose, and obtain a recognition result of the target application program for the attack action.
S506: Determine an evaluation result of the target application program based on a total quantity of attacks of the attack action and a quantity of successful recognition in the recognition result.

In an example embodiment of this specification, for the same target application program, the ratio of a quantity of times that a test action is successfully recognized in each attack test process to a total quantity of times of attacks can be used as an attack success rate. A lower attack success rate indicates a better capability in defending against spoofing attacks.

It can be understood that a structure shown in the embodiments of this specification does not constitute a specific limitation on the system in the embodiments of this specification. In some other embodiments of this specification, the above-mentioned system can include more or fewer components than those shown in the figure, or combine some components, or split some components, or have different component arrangements. The components in the figure can be implemented by hardware, software, or a combination of software and hardware.

The embodiments in this specification are described in a progressive manner. For the same or similar parts of the embodiments, references can be made to the embodiments. Each embodiment focuses on a difference from other embodiments. Particularly, the system embodiments are basically similar to the method embodiments, and therefore are described briefly. For related parts, references can be made to some descriptions in the method embodiments.

Specific embodiments of this specification are described above. Other embodiments fall within the scope of the appended claims. In some cases, actions or steps described in the claims can be performed in a sequence different from that in the embodiments and desired results can still be achieved. In addition, processes described in the accompanying drawings do not necessarily require a specific order or a sequential order shown to achieve the desired results. In some implementations, multitasking and parallel processing are also feasible or may be advantageous.

It is worthwhile to note that the above-mentioned examples are merely specific embodiments of the present disclosure. Clearly, the present disclosure is not limited to the above-mentioned embodiments, and a plurality of similar changes occur subsequently. All variations directly exported or associated with by a person skilled in the art from the content disclosed in the present disclosure shall fall within the protection scope of the present disclosure.

1. A face recognition attack test method, comprising:
determining at least one first pose of a test terminal;
determining a plurality of second poses of a target terminal, wherein a target application program is installed on the target terminal;
adjusting the target terminal to the plurality of second poses;
obtaining a recognition result of the target application program for a test action played by the test terminal when being in each second pose; and
if the recognition result is a recognition success result, determining an attack pose based on the second pose and the first pose that are corresponding to the recognition result.

2. The method according to claim 1, wherein the attack pose comprises distance data and angle data; and the determining an attack pose based on the second pose and the first pose that are corresponding to the recognition success result specifically comprises:
determining a relative distance between the test terminal and the target terminal based on the second pose and the first pose that are corresponding to the recognition success result, to obtain the distance data; and
determining, based on the second pose and the first pose that are corresponding to the recognition success result, a three-dimensional motion pose of the test terminal relative to the target terminal, and obtaining the angle data based on the three-dimensional motion pose.

3. The method according to claim 1, wherein the test terminal prestores test action data; and the playing, by the test terminal, the test action specifically comprises:
collecting a face recognition interface image of the target application program in real time in response to a received test task;
extracting action prompt information from the face recognition interface image; and
determining and playing a test action based on the action prompt information.

4. The method according to claim 1, wherein the test terminal prestores test action data; and the obtaining a recognition result of the target application program for a test action played by the test terminal when being in each second pose specifically comprises:
playing, by the test terminal, a test action according to a predetermined play sequence; and
for each test action, controlling the target terminal to traverse the plurality of second poses, and obtaining a recognition result of the target application program for the test action when being in each second pose.

5. A face recognition attack test method, applied to a face recognition attack test system, wherein the face recognition attack test system comprises a robot arm, a test terminal, a target terminal, and a control end;
the test terminal is configured to play a test action in at least one first pose in response to a test task delivered by the control end;
the robot arm is configured to adjust the target terminal to a plurality of second poses predetermined for the test task in response to the test task delivered by the control end;
the target terminal is disposed on the robot arm and installed with a target application program, and is configured to recognize the test action by using the target application program when moving to each second pose; and
the control end is configured to generate the test task and deliver the test task to the robot arm and the test terminal; and determine an attack pose based on the second pose and the first pose that are corresponding to a recognition success result of the target application program for the test action.

6. The method according to claim 5, wherein the attack pose comprises distance data and angle data; and the control end is specifically configured to determine a relative distance between the test terminal and the target terminal based on the second pose and the first pose that are corresponding to the recognition success result, to obtain the distance data; and determine, based on the second pose and the first pose that are corresponding to the recognition success result, a three-dimensional motion pose of the test terminal relative to the target terminal, and obtain the angle data based on the three-dimensional motion pose.

7. The method according to claim 5, wherein the test terminal prestores test action data; and the test terminal is specifically configured to: collect a face recognition interface image of the target application program in real time in response to a test task delivered by the control end; extract action prompt information from the face recognition interface image; and determine and play a test action based on the action prompt information.

8. The method according to claim 5, wherein the test terminal prestores test action data;
the test terminal is specifically configured to play a test action according to a predetermined play sequence; and
the control end is specifically configured to: for each test action, adjust a pose of the target terminal by using the robot arm, so the target terminal traverses the plurality of second poses, and obtains a recognition result of the target application program for the test action when being in each second pose.

9. A face recognition attack test system, comprising: a robot arm, a test terminal, a target terminal, and a control end;
the test terminal is configured to play a test action in at least one first pose in response to a test task delivered by the control end;
the robot arm is configured to adjust the target terminal to a plurality of second poses predetermined for the test task in response to the test task delivered by the control end;
the target terminal is disposed on the robot arm and installed with a target application program, and is configured to recognize the test action by using the target application program when moving to each second pose; and
the control end is configured to generate the test task and deliver the test task to the robot arm and the test terminal; and determine an attack pose based on the second pose and the first pose that are corresponding to a recognition success result of the target application program for the test action.

10. The system according to claim 9, wherein the robot arm comprises a controller, a driver, and an actuator;
the control end is specifically configured to determine a control instruction based on the plurality of second poses and a predetermined motion path of the target terminal; and
the controller is configured to execute the control instruction to control the driver to adjust a pose of the target terminal to the plurality of second poses.

11. (canceled)
